(19) United States
(12) Patent Application Publication
(10) Pub. No.: US 2003/0079198 A1
(43) Pub. Date: Apr. 24, 2003

(54) Method of forming, searching, or generating quasi-minimum tree providing optimum network configuration, and information recording medium which stores program thereof

(76) Inventor: Haruo Yamamoto, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/095,065

(22) Filed: Mar. 12, 2002

(30) Foreign Application Priority Data
Oct. 24, 2001 (JP) 2001-326526

(51) Int. Cl. G06F 17/50

(52) U.S. Cl. 716/13; 716/12

(57) ABSTRACT

A method for forming, searching, or generating a quasi-minimum tree providing an optimum network configuration, which provides an approximate solution to the Steiner problem. This method is a method for forming, searching, or generating a quasi-minimum tree providing an optimum network configuration connecting Steiner points v1 to v5 which are a plurality of vertexes defined by selecting vertexes and edges on an undirected graph which is a geometrical structure consisting of vertexes and weighted edges, wherein, a plurality of trees which do not share said vertexes and edges with one another are created or searched by connecting vertexes to one another beginning from those with which the distance, which provides the total sum of the weights for the edges included in a single path connecting between any two provisional points, is the shortest, while creating or searching a tree providing a path which includes no closed path and is tolerated to be branched; and then, said plurality of trees are connected to one another to provide a tree (a quasi-minimum tree) with which all of said plurality of vertexes defined, v1 to v5, are connected to one another, and the total sum of the weights for said edges included is at a quasi-minimum.

### BACKGROUND OF THE INVENTION

1. Field of the Invention

The present invention relates to a method for forming, searching, or generating a quasi-minimum tree providing an optimum network configuration and an information recording medium which records the program, particularly, to a method for forming, searching, or generating a quasi-minimum tree providing an optimum network configuration and an information recording medium which records the program that can be used for any applications which can be expressed as a combination of vertexes and edges, such as communications networks, water transportation networks, power line networks, road networks, railway networks, airline networks, integrated circuits and other physical network configurations, and lift diagrams, data flow graphs for compiling in computer languages, and other conceptual (virtual) network configurations, and that can realize design, scheduling, and optimization of them.

2. Prior Art

Conventionally, a method of computing a single path which connects between two defined vertexes on an undirected graph, and with which the total sum of the weights for the edges included is at minimum has already been proposed.

With the well-known Dijkstra method (E. W. Dijkstra “A Note on Two problems in Connection Graphs”, Numerical Mathematics, vol. 1, pp. 269-271, 1959), the operation is performed at high speed in a computation time period on the order of O (n²) (n is the number of vertexes included in an undirected graph).

However, any method of computing a tree which connects among three or more defined vertexes and with which the total sum of the weights for the edges included is at minimum has not been proposed.

The problem of creating a tree with which the total sum of the weights is at minimum is generally known as the Steiner problem, and has already been proved to be NP-complete problems (R. M. Karp: “Reducibility among Combinatorial Problem”, Complexity of Computer Computations, Plenum Press, New York, 1972).

In other words, it has already been mathematically proved that, if the latest computer is used, a few years, a several ten years, or a few hundred years would be required to perfectly solve the Steiner problem, and thus, there is no method of creating a tree with which the total sum of the weights is at minimum, within a time period which is sufficiently short from the viewpoint of practice.

### SUMMARY OF THE INVENTION

The present invention has been developed in consideration of the above-stated conventional situation, and the purpose thereof is to offer an approximate solution to the Steiner problem, offering a method for forming, searching, or generating a quasi-minimum tree providing an optimum network configuration that allows creating a tree which, on an undirected graph with which the respective edges are weighted, connects all Steiner points which are a plurality of vertexes defined, and with which the total sum of the weights for the edges included is at a quasi-minimum, and an information recording medium which records the program.

The invention as claimed in claim 1 provides a forming, searching, or generating method for forming, searching, or generating a quasi-minimum tree providing an optimum network configuration connecting Steiner points which are a plurality of vertexes defined by selecting vertexes and edges on an undirected graph which is a geometrical structure consisting of vertexes and weighted edges, wherein, in creating or searching a path for forming, searching or generating an optimum network configuration by selecting said vertexes and edges, a plurality of trees which do not share said vertexes and edges with one another are created or searched by connecting vertexes to one another beginning from those with which the distance, which provides the total sum of the weights for the edges included in a single path connecting between any two provisional points, is the shortest, while creating or searching a tree providing a path which includes no closed path and is tolerated to be branched; and then, said plurality of trees are connected to one another to provide a tree with which all of said plurality of vertexes defined, i.e., Steiner points are connected to one another, and the total sum of the weights for said edges included is at a quasi-minimum.

The invention as claimed in claim 2 provides a forming, searching, or generating method for forming, searching, or generating a quasi-minimum tree providing an optimum network configuration connecting Steiner points which are a plurality of vertexes defined by selecting vertexes and edges on an undirected graph which is a geometrical structure consisting of vertexes and weighted edges, wherein, in the course of forming or generating said quasi-minimum tree providing an optimum network configuration, a plurality of trees providing a path which includes no closed path and is tolerated to be branched are formed and generated at the same time, and the plurality of trees do not share said vertexes and edges with one another.

The invention as claimed in claim 3 provides a method of creating, searching, or generating a quasi-minimum tree providing an optimum network configuration as claimed in claim 1 or 2, wherein said method of creating, searching, or generating a quasi-minimum tree providing an optimum network configuration gradually generates or extends said tree by adding said vertexes and edges for connecting the vertexes one by one in sequence, respectively.

The invention as claimed in claim 4 provides a method of creating, searching, or generating a quasi-minimum tree providing an optimum network configuration as claimed in any one of claims 1 to 3, wherein said method of forming, searching, or generating a quasi-minimum tree providing an optimum network configuration forms or generates a new tree by connecting said trees to one another.

The invention as claimed in claim 5 provides a method of creating, searching, or generating a quasi-minimum tree providing an optimum network configuration as claimed in any one of claims 1 to 4, wherein said method of forming, searching, or generating a quasi-minimum tree providing an optimum network configuration has trees with said plurality of vertexes defined, i.e., Steiner points which number is k as the initial state of starting of forming, searching, or generating a quasi-minimum tree providing an optimum network configuration, and the respective trees are comprised of only one Steiner point which is different from one another.

The invention as claimed in claim 6 provides a method of creating, searching, or generating a quasi-minimum tree providing an optimum network configuration as claimed in any one of claims 1 to 5, wherein said method of forming, searching, or generating a quasi-minimum tree providing an optimum network configuration defines the total sum of the weights for the edges which are included in a single path connecting between any two provisional points on said undirected graph as the distance, and computes the distance between points, which is the shortest distance between the vertex and the tree, on said method of forming a quasi-minimum tree providing an optimum network configuration.

The invention as claimed in claim 7 provides a method of creating, searching, or generating a quasi-minimum tree providing an optimum network configuration as claimed in any one of claims 1 to 6, wherein said method of forming, searching, or generating a quasi-minimum tree providing an optimum network configuration defines the total sum of the weights for the edges which are included in a single path connecting between any two provisional points, and computes the distance between trees, which is the shortest distance between said trees.

The invention as claimed in claim 8 provides a method of creating, searching, or generating a quasi-minimum tree providing an optimum network configuration as claimed in any one of claims 1 to 7, wherein said method of forming, searching, or generating a quasi-minimum tree providing an optimum network configuration selects, in adding vertex to tree, a tree and a vertex to be added to the tree, an edge for connecting the vertex, respectively, on the basis of information about the distance between points, which is the shortest distance between said vertex and tree.

The invention as claimed in claim 9 provides a method of creating, searching, or generating a quasi-minimum tree providing an optimum network configuration as claimed in any one of claims 1 to 8, wherein said method of forming, searching, or generating a quasi-minimum tree providing an optimum network configuration selects, in connecting trees to one another, trees to be connected on the basis of the distance between trees, which is the shortest distance between said trees.

The invention as claimed in claim 10 provides a method of creating, searching, or generating a quasi-minimum tree providing an optimum network configuration as claimed in any one of claims 1 to 9, wherein said method of forming, searching, or generating a quasi-minimum tree providing an optimum network configuration performs either addition operation for vertex or connection operation for trees on the basis of the comparison of said distance between points with said distance between trees.

The invention as claimed in claim 11 provides a method of creating, searching, or generating a quasi-minimum tree providing an optimum network configuration as claimed in any one of claims 1 to 10, wherein said method of forming, searching, or generating a quasi-minimum tree providing an optimum network configuration identifies the tree to which a vertex belongs, and will not connect the vertexes which belong to the same tree, so that no closed path is formed on said undirected graph.

According to the respective inventions as claimed in claims 1 to 11, a quasi-minimum tree providing an optimum network configuration which, on an undirected graph with which the respective edges are weighted, connects all Steiner points which are a plurality of vertexes defined, and with which the total sum of the weights for the edges included is at a quasi-minimum can be efficiently created at high speed.

The invention as claimed in claims 12 to 22 provides a computer readable information recording medium which is used with a method for forming, searching, or generating a quasi-minimum tree providing an optimum network configuration as claimed in any one of said claims 1 to 11, wherein a program for executing said formation, search, or generation of a quasi-minimum tree providing an optimum network configuration is recorded.

The invention as claimed in claim 23 provides a computer readable information recording medium which records a program for creating or searching a path for forming or generating a quasi-minimum tree providing an optimum network configuration connecting Steiner points which are a plurality of vertexes defined by selecting vertexes and edges on an undirected graph which is a geometrical structure consisting of vertexes and weighted edges, wherein, in creating or searching a path for forming, searching or generating an optimum network configuration by selecting said vertexes and edges, the program causes the computer to execute processing comprising: a step for reading or inputting data of said undirected graph; a step for reading or inputting data of said Steiner points; a step for creating or searching a plurality of trees which do not share said vertexes and edges with one another by connecting vertexes to one another beginning from those with which the distance, which provides the total sum of the weights for the edges included in a single path connecting between any two provisional points, is the shortest, while creating or searching a tree providing a path which includes no closed path and is tolerated to be branched; a step for connecting said plurality of trees to one another to provide a tree with which all of said plurality of vertexes defined are connected to one another, and the total sum of the weights for said edges included is at a quasi-minimum; and a step for outputting the results of said respective steps.

According to the respective inventions as claimed in claims 12 to 23, a quasi-minimum tree providing an optimum network configuration which connects all Steiner points which are a plurality of vertexes defined by reading with a computer system, and with which the total sum of the weights for the edges included is at a quasi-minimum can be automatically created at high speed.

### BRIEF DESCRIPTION OF THE DRAWINGS

FIG. 1 is a drawing giving an undirected graph according to an embodiment of the present invention, with which each edge is weighted;

FIG. 2 is an explanatory drawing showing a quasi-minimum tree according to an embodiment of the present invention;

FIG. 3 is a drawing showing the starting point when creating a quasi-minimum tree according to an embodiment of the present invention;

FIG. 4 is a drawing showing the point of time 01 when creating a quasi-minimum tree according to an embodiment of the present invention;

FIG. 5 is a drawing showing the point of time 02 when creating a quasi-minimum tree according to an embodiment of the present invention;

FIG. 6 is a drawing showing the point of time 03 when creating a quasi-minimum tree according to an embodiment of the present invention;

FIG. 7 is a drawing showing the point of time 04 when creating a quasi-minimum tree according to an embodiment of the present invention;

FIG. 8 is a drawing showing the point of time 05 when creating a quasi-minimum tree according to an embodiment of the present invention;

FIG. 9 is a drawing showing the point of time 06 when creating a quasi-minimum tree according to an embodiment of the present invention;

FIG. 10 is a drawing showing the point of time 07 when creating a quasi-minimum tree according to an embodiment of the present invention;

FIG. 11 is a drawing showing the point of time 08 when creating a quasi-minimum tree according to an embodiment of the present invention;

FIG. 12 is a drawing showing the point of time 09 when creating a quasi-minimum tree according to an embodiment of the present invention;

FIG. 13 is a drawing showing the point of time 10 when creating a quasi-minimum tree according to an embodiment of the present invention;

FIG. 14 is a drawing showing the point of time 11 when creating a quasi-minimum tree according to an embodiment of the present invention;

FIG. 15 is a drawing showing the point of time 12 when creating a quasi-minimum tree according to an embodiment of the present invention;

FIG. 16 is a drawing showing the point of time 13 when creating a quasi-minimum tree according to an embodiment of the present invention;

FIG. 17 is a drawing showing the point of time 14 when creating a quasi-minimum tree according to an embodiment of the present invention;

FIG. 18 is a drawing showing the point of time 15 when creating a quasi-minimum tree according to an embodiment of the present invention;

FIG. 19 is a drawing showing the point of time 16 when creating a quasi-minimum tree according to an embodiment of the present invention;

FIG. 20 is a drawing showing the point of time 17 when creating a quasi-minimum tree according to an embodiment of the present invention;

FIG. 21 is a drawing showing the point of time 18 when creating a quasi-minimum tree according to an embodiment of the present invention;

FIG. 22 is a drawing showing the point of time 19 when creating a quasi-minimum tree according to an embodiment of the present invention;

FIG. 23 is a drawing showing the point of time 20 when creating a quasi-minimum tree according to an embodiment of the present invention;

FIG. 24 is a drawing showing the point of time 21 when creating a quasi-minimum tree according to an embodiment of the present invention;

FIG. 25 is a drawing showing the point of time 22 when creating a quasi-minimum tree according to an embodiment of the present invention;

FIG. 26 is a drawing showing the point of time 23 when creating a quasi-minimum tree according to an embodiment of the present invention;

FIG. 27 is a drawing showing the point of time 24 when creating a quasi-minimum tree according to an embodiment of the present invention;

FIG. 28 is a drawing showing the point of time 25 when creating a quasi-minimum tree according to an embodiment of the present invention;

FIG. 29 is a flow chart showing the sequence for the method of creating a quasi-minimum tree according to an embodiment of the present invention; and

FIG. 30 is a block diagram illustrating a computer system according to an embodiment of the present invention.

### DESCRIPTION OF THE PREFERRED EMBODIMENTS

Hereinbelow, an embodiment of the present invention will be described in detail.

(Fundamental Description)

In an embodiment of the present invention, v denotes a vertex. V denotes a set of vertexes. v is included in V. n denotes the number of elements of V. e denotes an edge. E denotes a set of edges. e is included in E. d denotes the weight for an edge. G denotes an undirected graph consisting of V and E. S denotes a set of Steiner points. S is included in V. k denotes the number of elements of S. G^{S} denotes a tree which includes S, and with which the total sum of d's provides a quasi-minimum. G^{S} will be hereafter abbreviated to “quasi-minimum tree”.

G^{W} denotes a tree included in G. Z denotes a set of G^{W}'s which share no vertex and edge with one another. G^{W} is included in Z. V^{Z} denotes the union of vertexes of G^{W} included in Z.

The total sum of d's which are included in a single path connecting between any two points is defined as the distance. When a certain vertex v is noted, the shortest distance between any G^{W} included in Z and the v is denoted by d^{p}(v). The shortest distance d^{p}(v) will be hereafter called the “distance between points”.

When a certain vertex v is noted, the shortest distance for the path connecting between any two G^{W}'s included in Z through the v is denoted by d^{t}(v). The shortest distance d^{t}(v) will be hereafter called the “distance between trees”.

Further, in the later described method of creating a quasi-minimum tree, v^{p}, v^{t}, P, X, and Y denote a variable to provisionally store a value, respectively. v^{p} and v^{t} denote a vertex, respectively. P, X, and Y denote a set of vertexes, respectively.

(Method of Creating Quasi-minimum Tree)

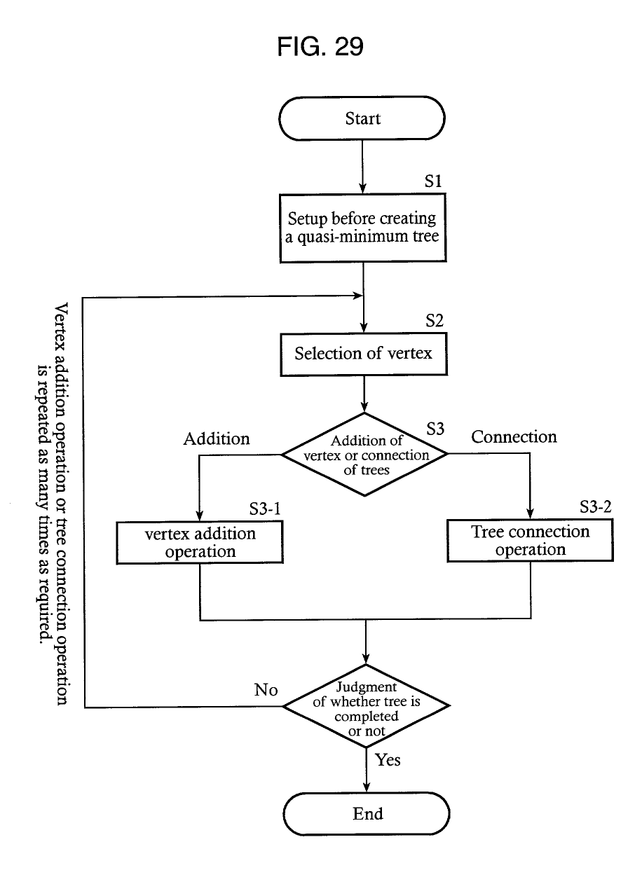

Hereinbelow, the method of creating a quasi-minimum tree will be described with reference also to FIG. 29.

The method of creating a quasi-minimum tree is comprised of three steps.

In step S1, the setup for creating a quasi-minimum tree is performed. In step S2, a vertex is selected.

In step S3, the vertex which is selected in step S2 is noted, and either of the vertex addition operation or the tree connection operation is provided. The operations in step S2 to step S3 are repeated until all the Steiner points are connected to one another to form a single tree.

In step S3-1, the vertex addition operation is performed. The vertex selected in step S2 is added to the tree of the nearest distance. The vertex added in step S3-1 is provisional, having the possibility of being reset, i.e., the possibility of being removed from the tree. Further, in step S3-1, besides the vertex addition operation being performed, the vertex selected in step S2 is noted, and the distance between points and the distance between trees for any vertex adjacent to that vertex are recomputed.

The distance between points and the distance between trees provide selection criteria in selecting the vertex in step S2.

With the method of creating a quasi-minimum tree, the vertex selection action in step S2 and the recomputation for the selection criteria in step S3-1 are alternately and repetitively performed.

Because the range of computation of the distance between points and the distance between trees is locally limited to around the vertex noted, the amount of computation required is small, and therefore, the quasi-minimum tree is created at an extremely high speed.

In step S3-2, the tree connection operation is performed. The two trees are connected to each other by the shortest single path through the vertex selected in step S2. The vertex which has been used as the connection path is incorporated in the quasi-minimum tree as a determinate one. The provisional vertexes which belong to the respective trees and have not been used as the connection path are reset as unnecessary vertexes, in other words, removed from the respective trees.

Hereinbelow steps S1 to S3 will be further described in detail.

(Step S1)

The variables are initialized. The value of V^{Z} is set at S. The value of X is set at φ (empty set). The value of any d^{p}(v) is set at ∞. The value of any d^{t}(v) is set at ∞. The value of any v^{p} is set at φ. The value of any v^{t} is set at φ. The value of any V^{W}(v) is set at φ.

Next, the setup for taking step 2 is performed.

The vertexes which are included in S are represented by vᵢ₁. For any vᵢ₁, the value of V^{W}(vᵢ₁) is set at {vᵢ₁}. The vertexes which are adjacent to vᵢ₁ and included in S are represented by vᵢ₂. When, for any vᵢ₂, d^{t}(vᵢ₂)>d(eᵢ₁, eᵢ₂) is met, the value of d^{t}(vᵢ₂) is set at d(eᵢ₁, eᵢ₂) and the value of v^{t}ᵢ₂ is set at vᵢ₁.

The vertexes which are adjacent to vᵢ₁ and not included in S, but included in V are represented by vᵢ₃. When, for any vᵢ₃, d^{p}(vᵢ₃)>d(eᵢ₁, eᵢ₃) is met, the value of d^{p}(vᵢ₃) is set at d(eᵢ₁, eᵢ₃), the value of v^{p}ᵢ₃ is set at vᵢ₁, and the value of V^{W}(vᵢ₃) is set at V^{W}(vᵢ₁).

(Step S2)

The vertex to be added to the tree is selected. Of the vertexes which are included in V and not included in V^{Z} or X, the vertex which provides the smallest value of d^{p} is selected. This vertex is represented by vᵢₚ. Also, of the vertexes which are included in V^{Z} or X, the vertex which provides the smallest value of d^{t} is selected. This vertex is represented by vᵢₜ.

(Step S3)

Which operation of the vertex addition operation (step 3-1) and the tree connection operation (step 3-2) is to be performed is determined.

The distance between points is compared with that between trees. When d^{p}(vᵢₚ)<d^{t}(vᵢₜ), step S3-1 is taken. When d^{t}(vᵢₜ). d^{p}(vᵢₚ), step S3-2 is taken.

(Step S3-1)

The vertex addition operation is performed. The information about the distance between points is updated. The vertexes which are adjacent to vᵢₚ, and not included in V^{Z} or X, but included in V, are represented by vᵢ₄. When, for any vᵢ₄, the value of d^{p}(vᵢ₄) is larger than the sum of d^{p}(vᵢₚ) and d(eᵢₚᵢ₄), the value of d^{p}(vᵢ₄) is set at the sum of d^{p}(vᵢₚ) and d(eᵢₚᵢ₄), the value of v^{p}ᵢ₄ is set at vᵢₚ, and the value of V^{W}(vᵢ₄) is set at V^{W}(vᵢₚ).

Next, the distance between trees is updated. The vertexes which are adjacent to vᵢₚ and included in V^{Z} or X are represented by vᵢ₅. When, for any vᵢ₅, the value of V^{W}(vᵢ₅) is different from the value of V^{W}(vᵢₚ), and the value of d^{t}(vᵢ₅) is larger than the sum of d^{p}(vᵢₚ), d^{p}(vᵢ₅) and d(eᵢₚᵢ₅), the value of d^{t}(vᵢ₅) is set at the sum of d^{p}(vᵢₚ), d^{p}(vᵢ₅) and d(eᵢₚᵢ₅), and the value of v^{t}(vᵢₚ) is set at vᵢₚ. Finally, the vertex is added, and vᵢₚis added to X.

(Step S3-2)

The two trees are connected to each other. By tracing v^{t}ᵢ₁ and vᵢ₁ back from vᵢ₁, respectively, the path from vᵢₜ to the respective two trees is derived. The set of vertexes which are included in the path is represented by P. The union of V^{W}(vᵢₜ), V^{W}(v^{t}ᵢ₁) and P is represented by Y.

First, the first tree is reset. The vertexes which are included in V^{W}(vᵢₜ) are represented by vᵢ₆. For any vᵢ₆, the value of d^{t}(vᵢ₆) is set at ∞, the value of v^{t}ᵢ₆ is set at φ, and the value of V^{W}(vᵢ₆) is set at Y. The vertexes which are not included in P, but included in X are represented by vᵢ₇. When, for any vᵢ₇, V^{W}(vᵢₜ) is equal to V^{W}(vᵢ₇), the value of d^{p}(vᵢ₇) is set at ∞, the value of d^{t}(vᵢ₇) is set at ∞, the value of v^{p}ᵢ₇ is set at φ, the value of v^{t}ᵢ₇ is set at φ, the value of V^{W}(vᵢ₇) is set at φ, and vᵢ is deleted from X.

Next, the second tree is reset. The vertexes which are included in V^{W}(v^{t}ᵢₜ) are represented by vᵢ₈. For any vᵢ₈, the value of d^{t}(vᵢ₈) is set at ∞, the value of v^{t}ᵢ₈ is set at φ, and the value of V^{W}(vᵢ₈) is set at Y.

When, for any vᵢ₇, V^{W}(vᵢₜ) is equal to V^{W}(vᵢ₇), the value of d^{p}(vᵢ₇) is set at ∞, the value of d^{t}(vᵢ₇) is set at ∞, the value of v^{p}ᵢ₇ is set at φ, the value of v^{t}ᵢ₇ is set at φ, the value of V^{W}(vᵢ₇) is set at φ, and vᵢ₇ is deleted from X.

Next, the two trees are connected to each other. The vertexes which are included in P are represented by vᵢ₉. For any vᵢ₉, the value of d^{p}(vᵢ₉) is set at 0 (zero), the value of d^{t}(vᵢ₉) is set at ∞, the value of v^{p}ᵢ₉ is set at φ, the value of v^{t}ᵢ₉ is set at φ, the value of V^{W}(vᵢ₉) is set at Y, and vᵢ₉ is added to V^{Z}.

Next, the setup for taking step S2 is performed.

The vertexes which are included in Y are represented by vᵢ₁₀. The vertexes which are adjacent to vᵢ₁₀ and not included in Y, but included in V^{Z} are represented by vᵢ₁₁. When, for any vᵢ₁₁, d^{t}(vᵢ₁₁)>d(eᵢ₁₀, eᵢ₁₁) is met, the value of d^{t}(vᵢ₁₁) is set at d(eᵢ₁₀, eᵢ₁₁) and the value of v^{t}ᵢ₁₁ is set at vᵢ₁₀.

The vertexes which are adjacent to vᵢ₁₀ and not included in V^{Z}, but included in V are represented by vᵢ₁₂. When, for any vᵢ₁₂, d^{p}(vᵢ₁₂)>d(eᵢ₁₀, eᵢ₁₂) is met, the value of d^{p}(vᵢ₁₂) is set at d(eᵢ₁₀, eᵢ₁₂), the value of v^{p}ᵢ₁₂ is set at vᵢ₁₀, and the value of V^{W}(vᵢ₁₂) is set at V^{W}(vᵢ₁₀).

Finally, when S is included in Y, the creation of the quasi-minimum tree is completed, and in any case other than that when S is included in Y, the operation is returned to step S2.

(Description of specific examples corresponding to fundamental description)

Here is a description of specific examples corresponding to the above fundamental description.

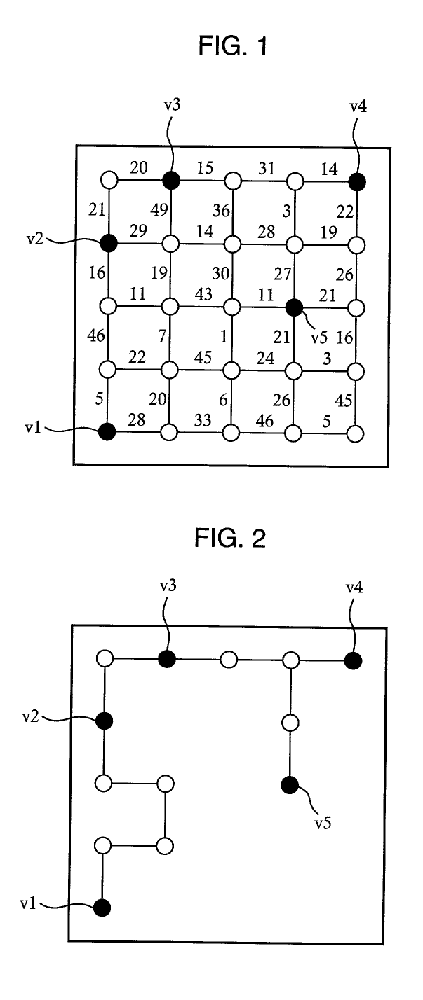

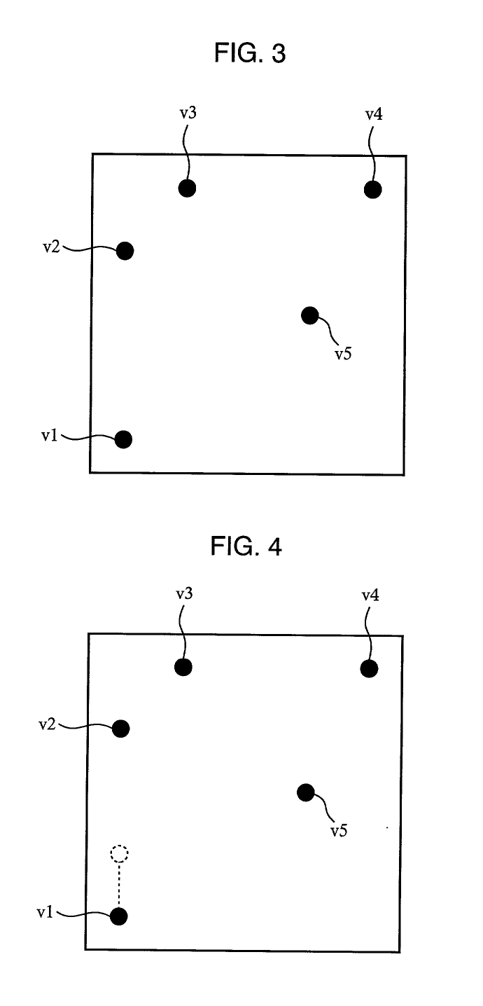

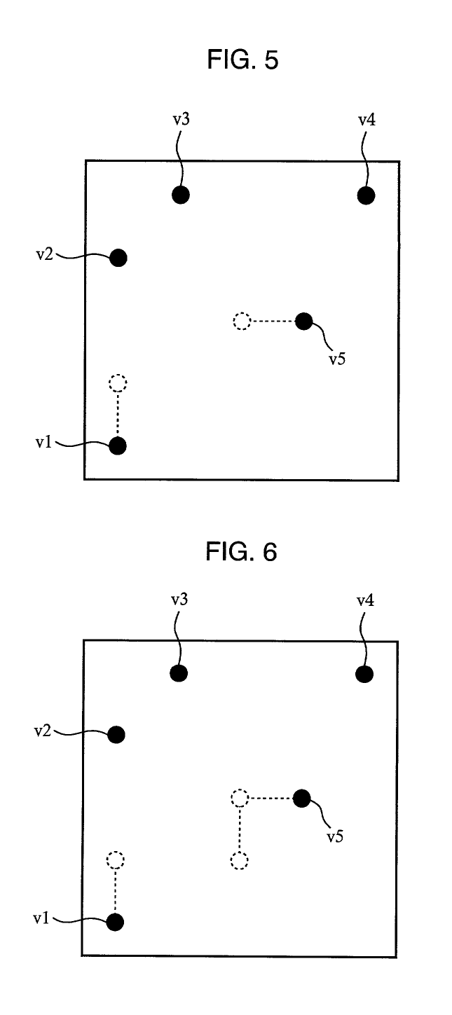

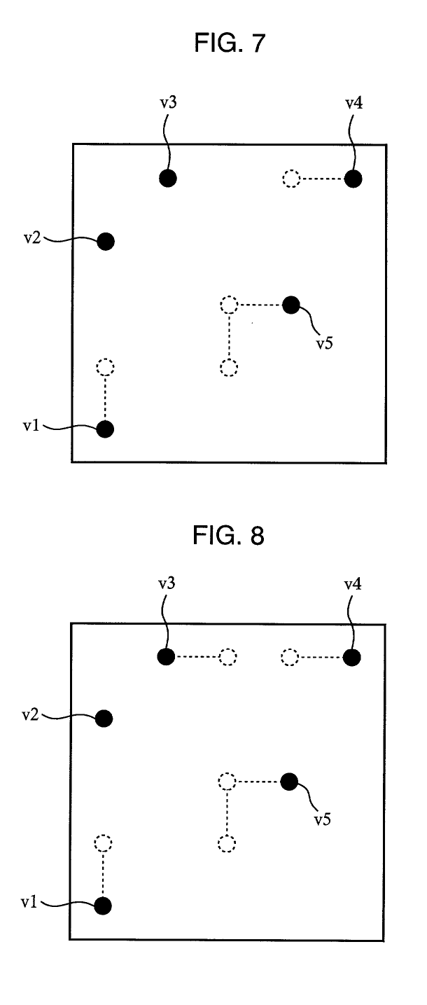

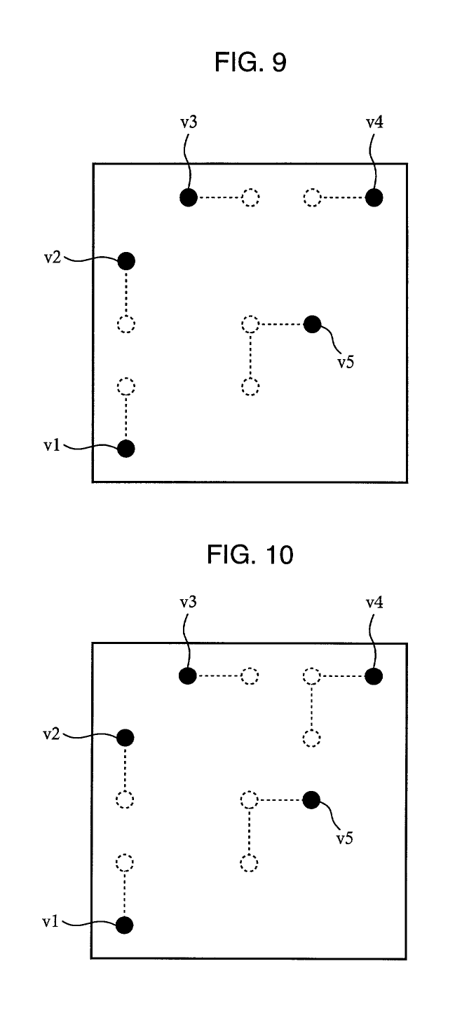

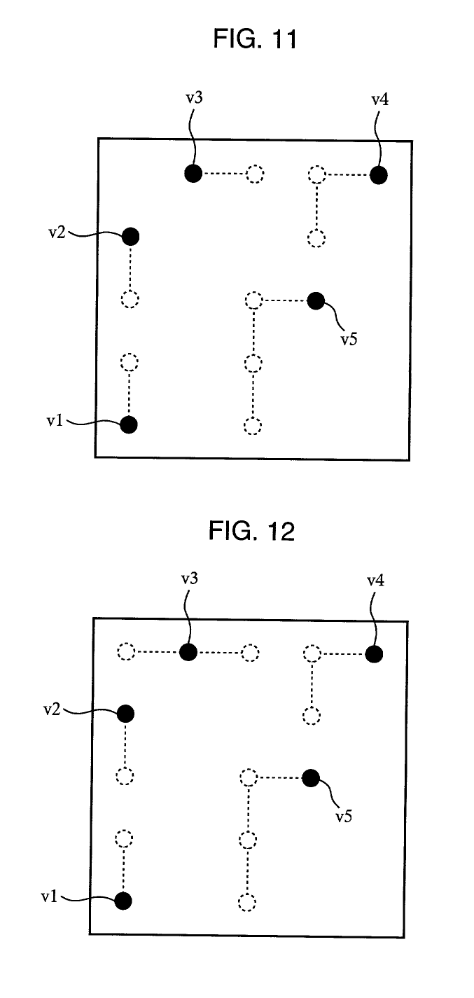

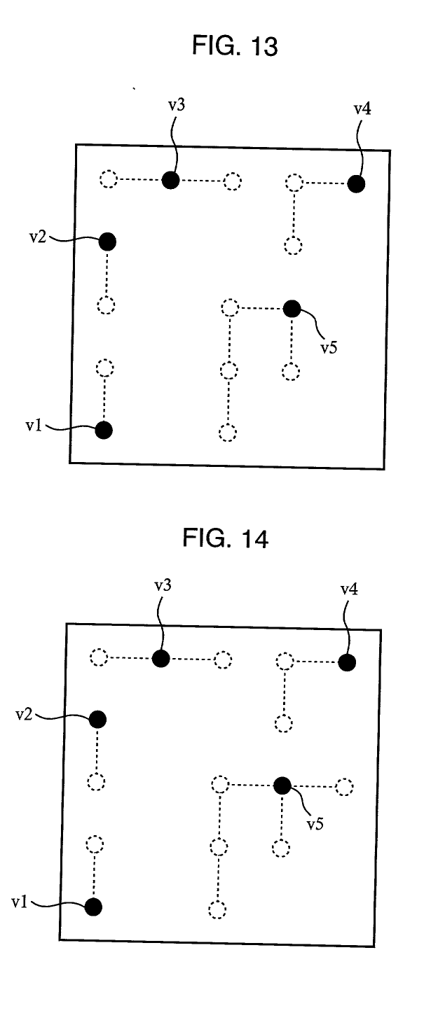

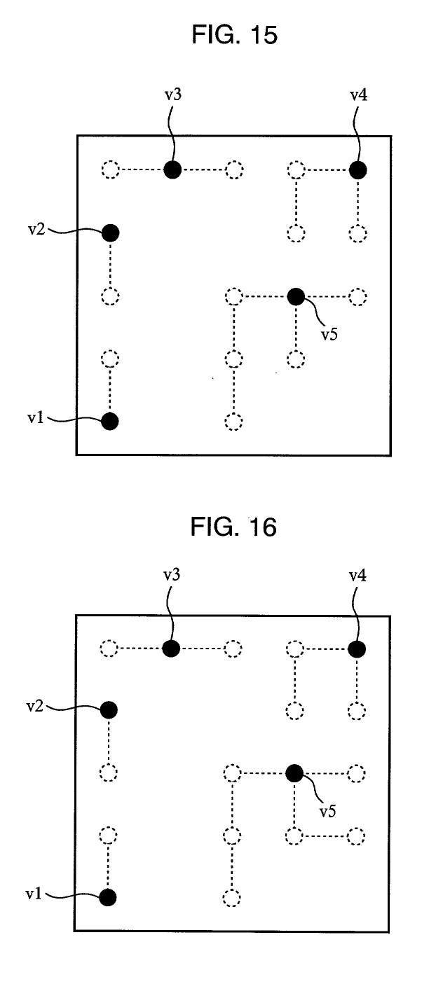

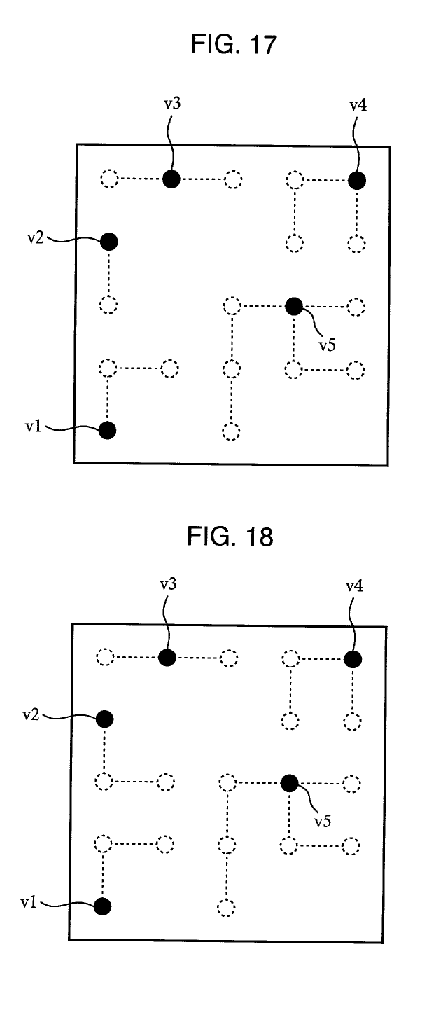

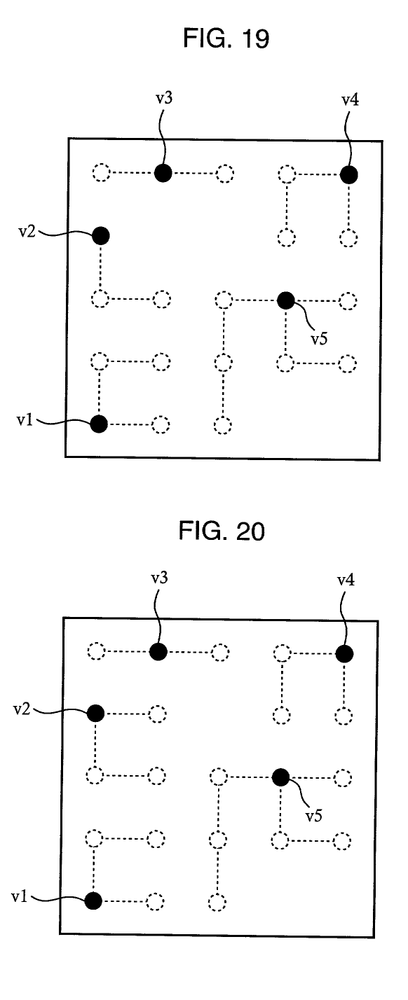

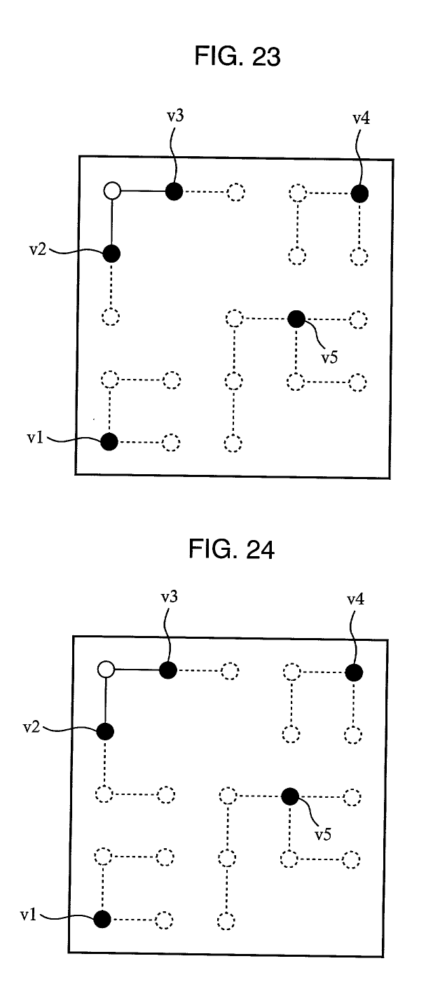

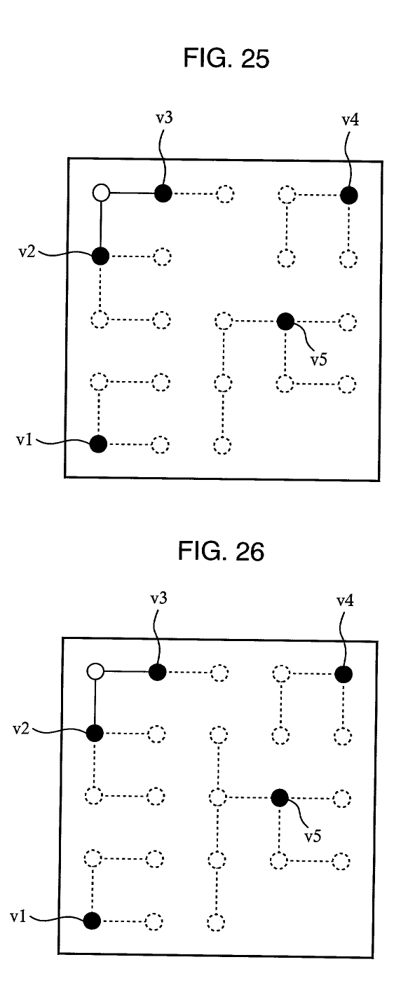

Examples of operation when the embodiment is applied to the undirected graph with which each edge is weighted with a value as shown in FIG. 1 are shown in FIG. 3 to FIG. 28. FIG. 2 shows the quasi-minimum tree created.

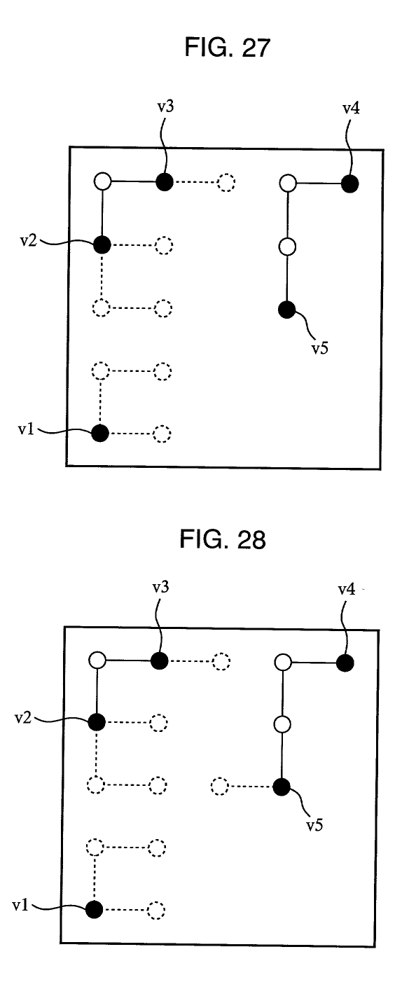

In each figure, black circular marks denote five Steiner points v1 to v5. A dotted line circular mark denotes a vertex provisionally built. A solid line circular mark (FIG. 27 and FIG. 28) denotes a vertex determinately built.

In each figure, a dotted line denotes a provisional tree, while a solid line denotes an established tree. FIG. 3 to FIG. 28 are arranged in the time series sequence.

FIG. 3 to FIG. 20 (starting point to point of time 17) show the time series sequence of creation that corresponds to the addition operation for the vertexes which are five Steiner points v1 to v5, i.e., the progress in which a plurality of trees gradually extend around the individual Steiner points v1 to v5 and provisional vertexes.

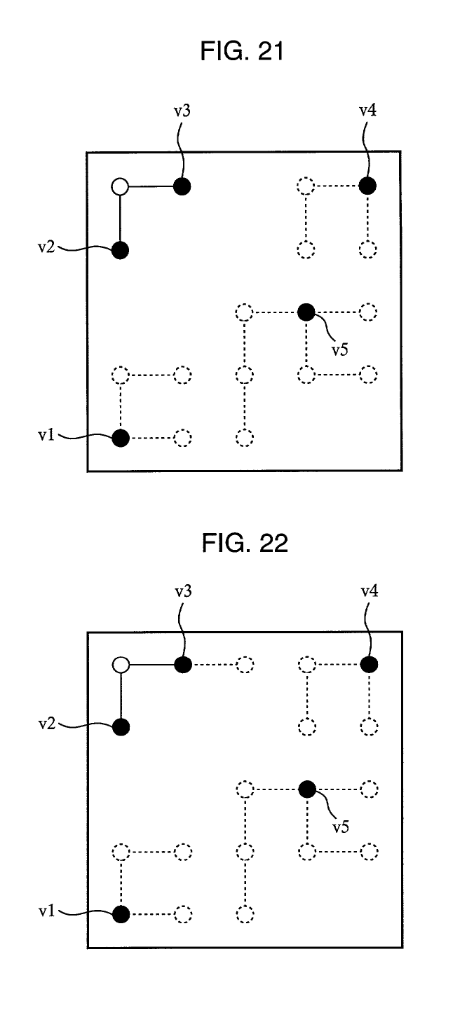

FIG. 21 (point of time 18) shows the result of connection operation for trees. The tree at upper left in FIG. 20 (point of time 17) and the tree at left middle in FIG. 20 are connected to each other, resulting in the determinate tree at upper left in FIG. 21 being formed. In connecting the trees to each other, the vertexes and edges other than are necessary for connection are removed.

As shown in FIG. 22 to FIG. 26 (point of time 18 to point of time 23), a plurality of trees gradually extend around the individual Steiner points v1 to v5 and provisional vertexes. Further, as shown in FIG. 27 (point of time 24), the two trees are connected to each other to form a new determinate tree. FIG. 28 (point of time 25) provides an example in which another tree is added to the Steiner point v5.

Thus, by connecting all the five Steiner points v1 to v5 and determinate vertexes to one another as shown in FIG. 2, a quasi-minimum tree with which the total sum of the weights for the edges is at a quasi-minimum is created.

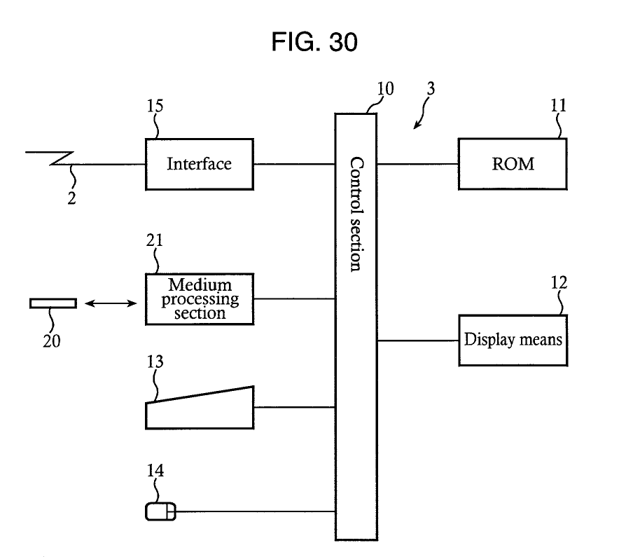

FIG. 30 shows an example of computer system for creating the above-stated quasi-minimum tree.

A computer device main body 3 in this computer system comprises a control section (CPU) 10, a program storing ROM 11, a display means 12, such as a CRT and a liquid crystal display, a keyboard 13, a mouse 14, an interface 15 for connecting to a communication means 2, such as the internet, an auxiliary recording means 16, such as a hard disk, and a medium processing section (medium reader/writer) 21 for reading processing of an information recording medium 20 (later described in detail).

As the information recording medium 20, a variety of media, such as a CD-ROM, a CD-R, a CD-RW, an MO, and various memory cards, may be used.

In the information recording medium 20 is stored a program for creating or searching a path to form or generate a quasi-minimum tree which provides an optimum network configuration connecting Steiner points which are a plurality of vertexes defined by selecting vertexes and edges on an undirected graph which is a geometrical structure consisting of vertexes and weighted edges.

Specifically, is stored a program for causing a computer to execute a process comprising a step for creating or searching a plurality of trees which do not share vertexes and edges with one another, by connecting vertexes to one another beginning from those with which the distance, which provides the total sum of the weights for the edges included in a single path connecting between any two provisional points, is the shortest, while creating or searching a tree providing a path which includes no closed path and is tolerated to be branched, in creating or searching a path for forming, searching or generating an optimum network configuration by selecting vertexes and edges; a step which connects said plurality of trees to one another to provide a tree (quasi-minimum tree) with which all of said selected plurality of vertexes are connected to one another, and the total sum of the weights for said edges included is at a quasi-minimum; and a step which outputs the results of said respective steps.

By reading the program in the information recording medium 20 into the medium processing section 21, a quasi-minimum tree with which the above-mentioned five Steiner points v1 to v5, and all the established vertexes are connected to one another, and the total sum of the weights for the edges is at a quasi-minimum can be automatically created at high speed.

The present invention can be applied to designing a communications network. It allows an optimum communications path to be selected. It allows an empty communications path to be selected according to the degree of congestion.

By changing the weighting as needed every time a customer is added, the traffic can be load-distributed to the entire communications network. By changing the weight into a physical distance from the degree of congestion, a communications path with which the transmission delay is short can be selected. Further, by setting the weight at the sum of the degree of congestion and the physical distance, a communications path to which both the degree of congestion and the transmission delay are taken into account can be selected.

If the present invention is applied to designing of an integrated circuit, an integrated circuit having a still smaller area and still fewer hierarchical structures can be realized, and the power consumption can be reduced. For a given area, more devices can be mounted, the yield can be improved.

If the present invention is applied to the diagram for a lift, more persons and more pieces of baggage can be transported for a given period of time.

The computation time for the present invention is on the order of O (kn²) (k is the number of Steiner points), thus the operation is performed at extremely high speed in an extremely short period of time.

For example, if a commercially available personal computer at a price as low as ¥100,000 is used, a tree of k=10 and n=100 can be created in a few seconds. Even when a quasi-minimum tree is to be created more than a few thousands of times, repetitively, as in designing an integrated circuit, the present invention makes it possible for the operation to be performed within a period of time which is sufficiently short from the viewpoint of practical use.

According to the present invention, an optimum (minimum) tree cannot be obtained, but, the total sum of the weights can be reduced by a few % to several ten %, when compared to that as given in the Dijkstra method being used as an approximate solution to the Steiner problem.

According to the present invention as stated above, the problem of creating a minimum tree on an undirected graph where the edges are weighted, which is an insoluble problem known as the Steiner problem, can be approximately solved. The present invention allows an automatic operation which requires no human support in selecting a vertex. Further, the present invention allows a desired tree to be created at extremely high speed in an extremely short period of time. In addition, according to the present invention, the total sum of the weights included in a particular tree can be held to a minimum.

Further, according to the present invention, an information recording medium from which a previously stored program is read out by the medium processing section for providing the above-stated effects can be offered.

What is claimed is:

1. A forming, searching, or generating method for forming, searching, or generating a quasi-minimum tree providing an optimum network configuration connecting Steiner points which are a plurality of vertexes defined by selecting vertexes and edges on an undirected graph which is a geometrical structure consisting of vertexes and weighted edges, wherein,
in creating or searching a path for forming, searching or generating an optimum network configuration by selecting said vertexes and edges,
a plurality of trees which do not share said vertexes and edges with one another are created or searched by connecting vertexes to one another beginning from those with which the distance, which provides the total sum of the weights for the edges included in a single path connecting between any two provisional points, is the shortest, while creating or searching a tree providing a path which includes no closed path and is tolerated to be branched; and then, said plurality of trees are connected to one another to provide a tree with which all of said plurality of vertexes defined, i.e., Steiner points are connected to one another, and the total sum of the weights for said edges included is at a quasi-minimum.

2. A forming, searching, or generating method for forming, searching, or generating a quasi-minimum tree providing an optimum network configuration connecting Steiner points which are a plurality of vertexes defined by selecting vertexes and edges on an undirected graph which is a geometrical structure consisting of vertexes and weighted edges, wherein,
in the course of forming or generating said quasi-minimum tree providing an optimum network configuration,
a plurality of trees providing a path which includes no closed path and is tolerated to be branched are formed and generated at the same time, and the plurality of trees do not share said vertexes and edges with one another.

3. A method of creating, searching, or generating a quasi-minimum tree providing an optimum network configuration as claimed in claim 1 or 2, wherein said method of creating, searching, or generating a quasi-minimum tree providing an optimum network configuration gradually generates or extends said tree by adding said vertexes and edges for connecting the vertexes one by one in sequence, respectively.

4. A method of creating, searching, or generating a quasi-minimum tree providing an optimum network configuration as claimed in any one of claims 1 to 3, wherein said method of forming, searching, or generating a quasi-minimum tree providing an optimum network configuration forms or generates a new tree by connecting said trees to one another.

5. A method of creating, searching, or generating a quasi-minimum tree providing an optimum network configuration as claimed in any one of claims 1 to 4, wherein said method of forming, searching, or generating a quasi-minimum tree providing an optimum network configuration has trees with said plurality of vertexes defined, i.e., Steiner points which number is k as the initial state of starting of forming, searching, or generating a quasi-minimum tree providing an optimum network configuration, and the respective trees are comprised of only one Steiner point which is different from one another.

6. A method of creating, searching, or generating a quasi-minimum tree providing an optimum network configuration as claimed in any one of claims 1 to 5, wherein said method of forming, searching, or generating a quasi-minimum tree providing an optimum network configuration defines the total sum of the weights for the edges which are included in a single path connecting between any two provisional points on said undirected graph as the distance, and computes the distance between points, which is the shortest distance between the vertex and the tree, on said method of forming a quasi-minimum tree providing an optimum network configuration.

7. A method of creating, searching, or generating a quasi-minimum tree providing an optimum network configuration as claimed in any one of claims 1 to 6, wherein said method of forming, searching, or generating a quasi-minimum tree providing an optimum network configuration defines the total sum of the weights for the edges which are included in a single path connecting between any two provisional points, and computes the distance between trees, which is the shortest distance between said trees.

8. A method of creating, searching, or generating a quasi-minimum tree providing an optimum network configuration as claimed in any one of claims 1 to 7, wherein said method of forming, searching, or generating a quasi-minimum tree providing an optimum network configuration selects, in adding vertex to tree, a tree and a vertex to be added to the tree, an edge for connecting the vertex, respectively, on the basis of information about the distance between points, which is the shortest distance between said vertex and tree.

9. A method of creating, searching, or generating a quasi-minimum tree providing an optimum network configuration as claimed in any one of claims 1 to 8, wherein said method of forming, searching, or generating a quasi-minimum tree providing an optimum network configuration selects, in connecting trees to one another, trees to be connected on the basis of the distance between trees, which is the shortest distance between said trees.

10. A method of creating, searching, or generating a quasi-minimum tree providing an optimum network configuration as claimed in any one of claims 1 to 9, wherein said method of forming, searching, or generating a quasi-minimum tree providing an optimum network configuration performs either addition operation for vertex or connection operation for trees on the basis of the comparison of said distance between points with said distance between trees.

11. A method of creating, searching, or generating a quasi-minimum tree providing an optimum network configuration as claimed in any one of claims 1 to 10, wherein said method of forming, searching, or generating a quasi-minimum tree providing an optimum network configuration identifies the tree to which a vertex belongs, and will not connect the vertexes which belong to the same tree, so that no closed path is formed on said undirected graph.

12. A computer readable information recording medium which is used with a forming, searching, or generating method for forming, searching, or generating a quasi-minimum tree providing an optimum network configuration connecting Steiner points which are a plurality of vertexes defined by selecting vertexes and edges on an undirected graph which is a geometrical structure consisting of vertexes and weighted edges, wherein,
in creating or searching a path for forming, searching or generating an optimum network configuration by selecting said vertexes and edges,
a plurality of trees which do not share said vertexes and edges with one another are created or searched by connecting vertexes to one another beginning from those with which the distance, which provides the total sum of the weights for the edges included in a single path connecting between any two provisional points, is the shortest, while creating or searching a tree providing a path which includes no closed path and is tolerated to be branched; and then, said plurality of trees are connected to one another to provide a tree with which all of said plurality of vertexes defined, i.e., Steiner points are connected to one another, and the total sum of the weights for said edges included is at a quasi-minimum, wherein
a program for executing said formation, search, or generation of a quasi-minimum tree providing an optimum network configuration is recorded.

13. A computer readable information recording medium which is used with a forming, searching, or generating method for forming, searching, or generating a quasi-minimum tree providing an optimum network configuration connecting Steiner points which are a plurality of vertexes defined by selecting vertexes and edges on an undirected graph which is a geometrical structure consisting of vertexes and weighted edges, wherein,
in the course of forming or generating said quasi-minimum tree providing an optimum network configuration,
a plurality of trees providing a path which includes no closed path and is tolerated to be branched are formed and generated at the same time, and the plurality of trees do not share said vertexes and edges with one another, wherein
a program for executing said formation, search, or generation of a quasi-minimum tree providing an optimum network configuration is recorded.

14. A computer readable information recording medium which is used with a method of creating, searching, or generating a quasi-minimum tree providing an optimum network configuration as claimed in claim 12 or 13, wherein said method of creating, searching, or generating a quasi-minimum tree providing an optimum network configuration gradually generates or extends said tree by adding said vertexes and edges for connecting the vertexes one by one in sequence, respectively, wherein
a program for executing said formation, search, or generation of a quasi-minimum tree providing an optimum network configuration is recorded.

15. A computer readable information recording medium which is used with a method of creating, searching, or generating a quasi-minimum tree providing an optimum network configuration as claimed in any one of claims 12 to 14, wherein said method of forming, searching, or generating a quasi-minimum tree providing an optimum network configuration forms or generates a new tree by connecting said trees to one another, wherein
a program for executing said formation, search, or generation of a quasi-minimum tree providing an optimum network configuration is recorded.

16. A computer readable information recording medium which is used with a method of creating, searching, or generating a quasi-minimum tree providing an optimum network configuration as claimed in any one of claims 12 to 15, wherein said method of forming, searching, or generating a quasi-minimum tree providing an optimum network configuration has trees with said plurality of vertexes defined, i.e., Steiner points which number is k as the initial state of starting of forming, searching, or generating a quasi-minimum tree providing an optimum network configuration, and the respective trees are comprised of only one Steiner point which is different from one another, wherein
a program for executing said formation, search, or generation of a quasi-minimum tree providing an optimum network configuration is recorded.

17. A computer readable information recording medium which is used with a method of creating, searching, or generating a quasi-minimum tree providing an optimum network configuration as claimed in any one of claims 12 to 16, wherein said method of forming, searching, or generating a quasi-minimum tree providing an optimum network configuration defines the total sum of the weights for the edges which are included in a single path connecting between any two provisional points on said undirected graph as the distance, and computes the distance between points, which is the shortest distance between the vertex and the tree, on said method of forming a quasi-minimum tree providing an optimum network configuration, wherein
a program for executing said formation, search, or generation of a quasi-minimum tree providing an optimum network configuration is recorded.

18. A computer readable information recording medium which is used with a method of creating, searching, or generating a quasi-minimum tree providing an optimum network configuration as claimed in any one of claims 12 to 17, wherein said method of forming, searching, or generating a quasi-minimum tree providing an optimum network configuration defines the total sum of the weights for the edges which are included in a single path connecting between any two provisional points, and computes the distance between trees, which is the shortest distance between said trees, wherein
a program for executing said formation, search, or generation of a quasi-minimum tree providing an optimum network configuration is recorded.

19. A computer readable information recording medium which is used with a method of creating, searching, or generating a quasi-minimum tree providing an optimum network configuration as claimed in any one of claims 12 to 18, wherein said method of forming, searching, or generating a quasi-minimum tree providing an optimum network configuration selects, in adding vertex to tree, a tree and a vertex to be added to the tree, an edge for connecting the vertex, respectively, on the basis of information about the distance between points, which is the shortest distance between said vertex and tree, wherein
a program for executing said formation, search, or generation of a quasi-minimum tree providing an optimum network configuration is recorded.

20. A computer readable information recording medium which is used with a method of creating, searching, or generating a quasi-minimum tree providing an optimum network configuration as claimed in any one of claims 12 to 19, wherein said method of forming, searching, or generating a quasi-minimum tree providing an optimum network configuration selects, in connecting trees to one another, trees to be connected on the basis of the distance between trees, which is the shortest distance between said trees, wherein
a program for executing said formation, search, or generation of a quasi-minimum tree providing an optimum network configuration is recorded.

21. A computer readable information recording medium which is used with a method of creating, searching, or generating a quasi-minimum tree providing an optimum network configuration as claimed in any one of claims 12 to 20, wherein said method of forming, searching, or generating a quasi-minimum tree providing an optimum network configuration performs either addition operation for vertex or connection operation for trees on the basis of the comparison of said distance between points with said distance between trees, wherein
a program for executing said formation, search, or generation of a quasi-minimum tree providing an optimum network configuration is recorded.

22. A computer readable information recording medium which is used with a method of creating, searching, or generating a quasi-minimum tree providing an optimum network configuration as claimed in any one of claims 12 to 21, wherein said method of forming, searching, or generating a quasi-minimum tree providing an optimum network configuration identifies the tree to which a vertex belongs, and will not connect the vertexes which belong to the same tree, so that no closed path is formed on said undirected graph, wherein
a program for executing said formation, search, or generation of a quasi-minimum tree providing an optimum network configuration is recorded.

23. A computer readable information recording medium which records a program for creating or searching a path for forming or generating a quasi-minimum tree providing an optimum network configuration connecting Steiner points which are a plurality of vertexes defined by selecting vertexes and edges on an undirected graph which is a geometrical structure consisting of vertexes and weighted edges, wherein,
in creating or searching a path for forming, searching or generating an optimum network configuration by selecting said vertexes and edges,
the program causes the computer to execute processing comprising:
a step for reading or inputting data of said undirected graph;
a step for reading or inputting data of said Steiner points;
a step for creating or searching a plurality of trees which do not share said vertexes and edges with one another by connecting vertexes to one another beginning from those with which the distance, which provides the total sum of the weights for the edges included in a single path connecting between any two provisional points, is the shortest, while creating or searching a tree providing a path which includes no closed path and is tolerated to be branched;
a step for connecting said plurality of trees to one another to provide a tree with which all of said plurality of vertexes defined are connected to one another, and the total sum of the weights for said edges included is at a quasi-minimum; and
a step for outputting the results of said respective steps.
